(19) United States
(12) Patent Application Publication
(10) Pub. No.: US 2004/0007834 A1
(43) Pub. Date: Jan. 15, 2004

(54) Device for guarding against electrostatic discharge and electromagnetic influences

(76) Inventors: Friedrich Kohler, Meitingen, DE (US); Holger Hein, Augsburg, DE (US); Wilhelm Neukam, Bobingen, DE (US); Frank Muller-Augste, Bobingen, DE (US); August Scherer, Dinkelscherben, DE (US)

Correspondence Address: LERNER AND GREENBERG, P.A., POST OFFICE BOX 2480, HOLLYWOOD, FL, 33022-2480, US

(21) Appl. No.: 10/607,523

(22) Filed: Jun. 26, 2003

(30) Foreign Application Priority Data
Jun. 26, 2002 (DE) 102 28 633.7

(51) Int. Cl. F16J 15/08

(52) U.S. Cl. 277/650; 277/647

(57) ABSTRACT

A device for protecting against electrostatic discharge and electromagnetic influences on electronic components in a housing. An element, for instance an electrical terminal or an operating element, leads through an I/O shield that covers a housing aperture, and the element is sealed with a sealing layer. The layer is so constructed that electrical contact with the sealing layer exists on the edges of the housing aperture.

### BACKGROUND OF THE INVENTION

Field of the Invention

The invention relates to a device for protecting against electrostatic discharge and electromagnetic influences on electronic components, in a housing comprising an element such as an electrical terminal or an operating element, whereby the element is led through an I/O shield which covers an housing aperture, and the element is sealed with a sealing layer.

Electrostatic charges that are harmful to electronic components originate in nature and in humans who work with electronic components and assemblies, as well as in objects that are moved more or less rapidly over the course of manufacturing processes. Electrostatic discharges can cause damage to electronic components which frequently manifests itself only in later operation. Furthermore, in devices with electronic components, an electromagnetic compatibility must be maintained.

When an electrical device or its housing includes a recess which serves for leading electrical terminals or operating elements outside the housing, these openings are weak points in the shielding against electromagnetic fields and in the tapping of electrostatic discharges. In order to counteract this problem, the housing recesses are covered by what are known as I/O shields, which consist of conductive metal or plates. The electrical terminal or operating element is then led outside through the I/O shield and is shielded against electrostatic discharge or electromagnetic fields by an electrically conductive seal. The disadvantage of that embodiment is that electromagnetic discharge is always tapped by way of several transition resistances. A resistance chain forms from the following transition resistances:

housing—I/O shield,

I/O shield—seal, and

seal—electrical terminal or operating element.

The large number of transition resistances increases the risk of an excessively high transition resistance and, in the worst case, leads to an electrostatic discharge across the protected component.

### SUMMARY OF THE INVENTION

It is accordingly an object of the invention to provide a device for protecting against electrostatic discharge and electromagnetic influences on electronic components, which overcomes the above-mentioned disadvantages of the heretofore-known devices and methods of this general type and which provides a solution with smaller transition resistances.

With the foregoing and other objects in view there is provided, in accordance with the invention, a device for protecting against electrostatic discharge and electromagnetic influences on electronic components in a housing, comprising:

an I/O shield covering a housing aperture formed in the housing;

an element, such as an electrical terminal or an operating element, extending through the I/O shield into the housing; and

a sealing layer disposed to seal the housing aperture and to form an electrical contact with the edges of the housing aperture.

In other words, the objects of the invention are achieved with the novel device provided for an element, for instance an electrical terminal or operating element, that is led through an I/O shield which covers an housing aperture. The element is sealed with a sealing layer, the layer being constructed so that there is electrical contact with the edges of the housing aperture.

The advantage of the inventive embodiment is that the electrical contact between the sealing layer and the housing exterior or interior and/or the wall of the housing aperture brings about a reduction of transition resistance chains by the transition resistance of:

housing—I/O shield.

Electrostatic discharges are tapped directly across the electrically conductive sealing layer and the housing. In an inventive embodiment, only the following two transition resistances remain:

electrically conductive seal—housing and

electrically conductive seal—plug or electrical terminal or operating element.

In accordance with an added feature of the invention, the electrically conductive sealing layer sits in positive engagement, i.e., in form lock, with the housing aperture, but it also exceeds the dimensions of the housing aperture such that the electrically conductive seal is pressed between the I/O shield and the housing when the I/O shield is fastened from the exterior or interior of the housing. This expediently reduces the transitional resistance between the housing and the electrically conductive sealing layer.

In accordance with an additional feature of the invention, the shape of the housing aperture is accounted for in that the I/O shield is U-shaped or trough-shaped. This leads to an improved shielding and protection against electrostatic discharges or electromagnetic fields, while taking into account the existing structural shape of the electrical terminal or operating element. Accordingly, such an I/O shield can be utilized, without any modifications, on housings and electronic components and their operating elements or electrical terminals, whereby the options for electronic component mounting variations are expanded.

Other features which are considered as characteristic for the invention are set forth in the appended claims.

Although the invention is illustrated and described herein as embodied in a device for guarding against electrostatic discharge and electromagnetic influences, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a sectional side view of a device for shielding electrostatic discharges and electromagnetic fields with a spring plate according to the prior art;

FIG. 2 is a sectional side view of a device for shielding electrostatic discharges and electromagnetic fields with a flat plate according to the prior art;

FIG. 3 is a sectional side view of a device for shielding electrostatic discharges and electromagnetic fields according to the invention; and

FIG. 3A is a similar view illustrating an alternative embodiment according to the invention.

### DESCRIPTION OF THE PREFERRED EMBODIMENTS

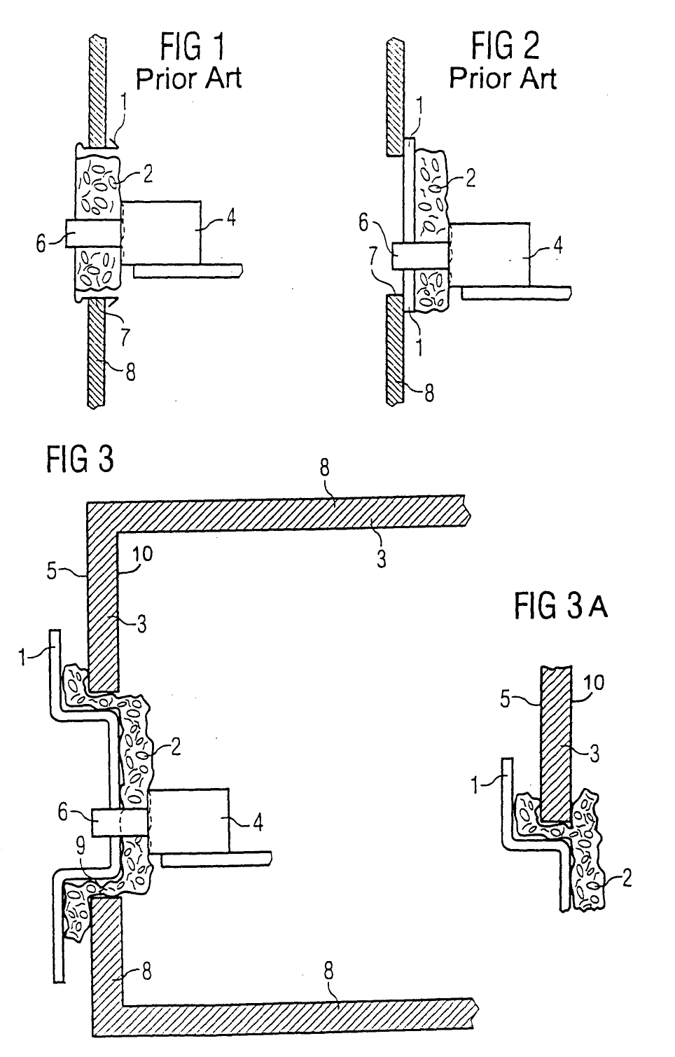

Referring now to the figures of the drawing in detail and first, particularly, to FIG. 1 thereof, there is shown a prior art device for protecting against electrostatic discharge and electromagnetic influences on electronic components 4. The electronic component 4 is disposed in a housing 8. A housing aperture 7 is filled in by a positively engaging, i.e., form-locked spring plate forming an I/O shield 1. An electrical terminal 6 or operating element 6 of the component 4 is guided through the spring plate. The lead-through is sealed with a seal 2 against electrostatic discharge or electromagnetic fields. If, for example, the electrical terminal is touched with an electrostatically charged body, the discharge occurs across the following transition resistance chain:

housing 8—I/O shield 1;

I/O shield 1—seal 2; and

seal 2—electrical terminal 6 or operating element 6.

The same thing happens with the prior art device represented in FIG. 2 for protecting against electrostatic discharge and electromagnetic influences on electronic components. There, an I/O shield 1 is constructed from an electrically conductive plate, its dimensions being larger than those of the housing aperture 7.

FIG. 3 represents the device according to the invention for protecting against electrostatic discharge and electromagnetic influences on electronic components. Here, the I/O shield 1 is attached to the housing recess 7, and the sealing layer 2 is disposed between the housing 8 and the I/O shield 1. Here, the electrically conductive seal 2 is attached not only for sealing the electrical terminal 6 or operating element 6 with respect to the I/O shield 1, as in the prior art, but also for sealing with respect to the I/O shield 1 and the housing recess 7.

In order to achieve the novel assembly, an electrically conductive seal 2 is inserted between the I/O shield 1 and the housing wall 3 during the assembly process. This seal surrounds the housing recess 7 at least to such an extent that, to the entire edge of the housing recess 7, an electrical connection to the electrically conductive seal 2 exists.

The sealing material 2 may contact the edges of the aperture, i.e., the wall surfaces 9 that define the aperture. In the alternative, or additionally, the electrical contact may be made at exterior wall surfaces 5 of the housing 8. As shown in FIG. 3A, the sealing layer 2 may form the electrical contact at interior wall surfaces 10 of the housing 8.

The electrical terminal 6 or the operating element 6 is led through the I/O shield 1 and sealed or shielded against electrostatic discharge and electromagnetic fields with the electrically conductive seal 2.

We claim:

1. A device for protecting against electrostatic discharge and electromagnetic influences on electronic components in a housing, comprising:
an I/O shield covering a housing aperture formed in the housing;
an element extending through said I/O shield into the housing; and
a sealing layer disposed to seal said housing aperture and to form an electrical contact with the edges of said housing aperture.

2. The device according to claim 1, wherein said element is an electrical terminal or an operating element.

3. The device according to claim 1, wherein the housing has wall surfaces defining said housing aperture and said sealing layer forms the electrical contact with said wall surfaces of said housing aperture.

4. The device according to claim 1, wherein the housing has exterior wall surfaces, and the electrical contact with said sealing layer is formed at the exterior wall surfaces.

5. The device according to claim 1, wherein the housing has interior wall surfaces, and the electrical contact with said sealing layer is formed at the interior wall surfaces.

6. The device according to claim 1, wherein said sealing layer consists of electrically conductive material.

7. The device according to claim 1, wherein said sealing layer comprises readily malleable electrically conductive material.

8. The device according to claim 1, wherein said sealing layer is disposed between the housing and said I/O shield.

9. The device according to claim 1, wherein said sealing layer has dimensions exceeding dimensions of said housing aperture.

10. The device according to claim 1, wherein said I/O shield has a U-shaped form.

11. The device according to claim 1, wherein said I/O shield has a trough-shaped form.
